(19) United States
(12) Patent Application Publication
(10) Pub. No.: US 2014/0299418 A1
(43) Pub. Date: Oct. 9, 2014

(54) Lifting Fork Board, Transport Device Provided Therewith, and Method for Transporting a Cargo

(71) Applicant: Gebr. Meijer St. Jabik B.V., Sint Jacobiparochie (NL)

(72) Inventor: Hendrik Meijer, Sint Jacobiparochie (NL)

(73) Assignee: Gebr. Meijer St. Jabik B.V., Sint Jacobiparochie (NL)

(21) Appl. No.: 14/247,674

(22) Filed: Apr. 8, 2014

(30) Foreign Application Priority Data
Apr. 9, 2013 (NL) 2010599
Nov. 18, 2013 (NL) 2011814

(51) Int. Cl. B66F 9/08; B66F 9/22

(52) U.S. Cl. CPC B66F 9/08; B66F 9/22
USPC 187/234

(57) ABSTRACT

A lifting fork board includes: a frame provided with coupling means for coupling the fork board to a transport vehicle; an upright arranged on the frame and provided with a recess; and a cylinder arranged wholly or partially in the recess of the upright for the purpose of lifting the frame.

### CROSS REFERENCE TO RELATED APPLICATIONS

This application claims priority to Netherlands Patent Applications Nos. 2010599 and 2011814 filed Apr. 9, 2013 and Nov. 18, 2013, respectively, the disclosures of which are hereby incorporated in their entirety by reference.

### BACKGROUND OF THE INVENTION

1. Field of the Invention

The present invention relates to a lifting fork board which is applied in practice for displacing goods with a fork-lift truck.

2. Description of Related Art

For the purpose of displacing goods use is usually made in practice of fork-lift trucks, wherein the forks are connected to the fork-lift truck using a fork board. The forks can usually be adjusted here in a horizontal direction, particularly in width direction of the fork-lift truck. It is further known in practice to provide a system, such as a front part as alternative to a front mast, wherein the forks are height-adjustable relative to the mast and/or the chassis of the fork-lift truck on which the forks are mounted. This achieves that additional working height is realized without increasing the headroom of the fork-lift truck.

One of the problems occurring in practice with fork boards, particularly fork boards provided with height-adjustable forks, is the risk of cargo falling off the forks while they are located at height. This results in a not inconsiderable safety hazard during picking up, displacing and/or setting down of goods.

### SUMMARY OF THE INVENTION

The present invention has for its object to provide a fork board which, among other things, reduces and preferably wholly obviates said safety hazard and other problems.

This object is achieved with a lifting fork board according to the present invention, the lifting fork board comprising:
a frame provided with coupling means for coupling the fork board to a transport vehicle;
an upright arranged on the frame and provided with a recess; and
a cylinder arranged wholly or partially in the recess of the upright for the purpose of lifting the frame.

Providing an upright of the frame of the fork board with a recess according to the invention enables a cylinder to be wholly or partially arranged therein. This achieves that the fork board is movable as a whole in a substantially vertical direction, with the forks being also moveable in a substantially vertical direction. Forks are hereby unable to move for instance independently or semi-independently of each other, and cargo always remains in straight position on the forks. The possibility of cargo falling off the forks is therefore also prevented. This results in a safe fork board whereby safety is guaranteed under all normal conditions.

An additional advantage of providing a cylinder of the fork board wholly or partially in a recess of an upright of the fork board is that the robustness of the fork board according to the invention is further increased. In the fork board according to the invention there is in principle no arm present between the uprights of the board, which have to transmit the forces, and a cylinder. The force transmission is hereby improved significantly and weak spots caused by possibly occurring high peak loads are avoided. This further increases the safety of the fork board according to the invention.

The forks of the fork board according to the invention can be embodied as conventional forks, although it is also possible to use roller forks.

In an advantageous preferred embodiment according to the present invention the invention comprises contact elements for moving the frame in or along a guide, wherein the guide is provided in or on the vehicle.

The effect of the contact elements is a good guiding. These contact elements are embodied in a currently preferred embodiment as wear strips. Use can additionally or alternatively also be made of other contact elements such as edges, strips, slide blocks. Because of the contact elements the substantially vertical guiding will always be straight. The forks hereby remain at all times in the same substantially horizontal plane under normal conditions, whereby cargo will not slide on the forks and safety remains guaranteed.

In a currently preferred embodiment the cylinder housing is provided in the recess of the upright. Because the cylinder housing is provided in the recess and because the fork board is pressed upward by the cylinder, the cylinder is provided as it were upside down in the fork board. The control of forces is hereby further improved.

In a currently preferred embodiment according to the present invention the fork board further comprises at least two uprights, wherein at least two uprights are provided with a cylinder. The fork board is hereby driven at least at two points, preferably on either side of the fork board. If desired, it is possible according to the invention to provide additional uprights and/or additional cylinders.

In an advantageous preferred embodiment according to the present invention the fork board comprises an integrated coupling with which the cylinders are mutually connected.

The coupling is preferably a hydraulic channel with which oil can be transferred from the one cylinder provided in an upright on a first side of the fork board to another cylinder provided in another upright on a second side of the fork board. Because an integrated channel is provided, oil need only be supplied from for instance one side. The operational reliability is hereby increased. In addition, arranging of the fork board according to the invention on an existing fork-lift truck is hereby simplified.

In a currently preferred embodiment the hydraulic channel comprises a bore in the frame of the fork board. Such a bore can alternatively be provided in or on a substantially horizontal connecting beam between a left-hand part and a right-hand part, i.e. the left-hand side and right-hand side, of the fork board as seen in the direction of travel of a fork-lift truck provided with a fork board according to the invention. A hydraulic coupling is hereby preferably realized between the left and right-hand cylinders of the lifting fork board according to the invention.

In a further advantageous preferred embodiment according to the present invention the frame of the fork board further comprises a transparent cover plate for safeguarding the frame.

Providing a cover plate avoids the possibility of objects such as body parts being placed through the frame of the fork board while it is for instance in motion. This avoids the possibility of such objects becoming jammed between the moving frame of the fork board and parts of the vehicle. This increases the safety of use of the fork board according to the invention. Such a cover plate is preferably embodied in a transparent material so as to optimize the view of the driver of the vehicle, such as the fork-lift truck driver. The cover plate is for instance manufactured from transparent plexiglass.

In an advantageous preferred embodiment according to the present invention the invention comprises a fork board further comprising horizontal fork shifting means. Providing the fork board with a so-called horizontal fork shifting means enables the mutual distance between the forks to be adjusted to the dimensions of the cargo to be picked up and transported. This further increases the flexibility of the fork board according to the invention.

The invention further relates to a transport vehicle, such as a fork-lift truck, provided with a fork board as described above.

Such a transport vehicle provides the same effects and advantages as those described for the fork board. A transport vehicle is particularly a fork-lift truck. The fork board according to the invention can also be applied in other transport vehicles, including for instance a stacker, a truck-mounted forklift truck and a reach truck.

The invention further also relates to a method for transporting a cargo, comprising of providing a fork board and/or transport vehicle as described above.

Such a method provides the same effects and advantages as those described for the fork board and/or the transport vehicle. Goods are in particular picked up, optionally placed on a pallet or slip sheet, displaced with the vehicle and set down at the desired location. The fork board is connected here during use, optionally via a mast, to the transport vehicle in order to make an additional, substantially vertical, movement of the forks possible. In addition, a type of free-lift is hereby achieved.

### BRIEF DESCIPTION OF THE DRAWINGS

Further advantages, features and details of the invention are elucidated on the basis of the preferred embodiments thereof, wherein reference is made to the accompanying drawings, in which:

FIG. 1 shows a view of a transport vehicle provided with a fork board according to the invention;

FIGS. 2 and 3 show a front and rear view in partial section of a first embodiment of a fork board according to the invention;

FIGS. 4 and 5 show a front and rear view of a second embodiment of a fork board according to the invention;

FIGS. 6 and 7 show a front and rear view of a third embodiment of a fork board according to the invention; and

FIG. 8 shows a fourth embodiment of a fork board according to the invention.

### DESCRIPTION OF THE INVENTION

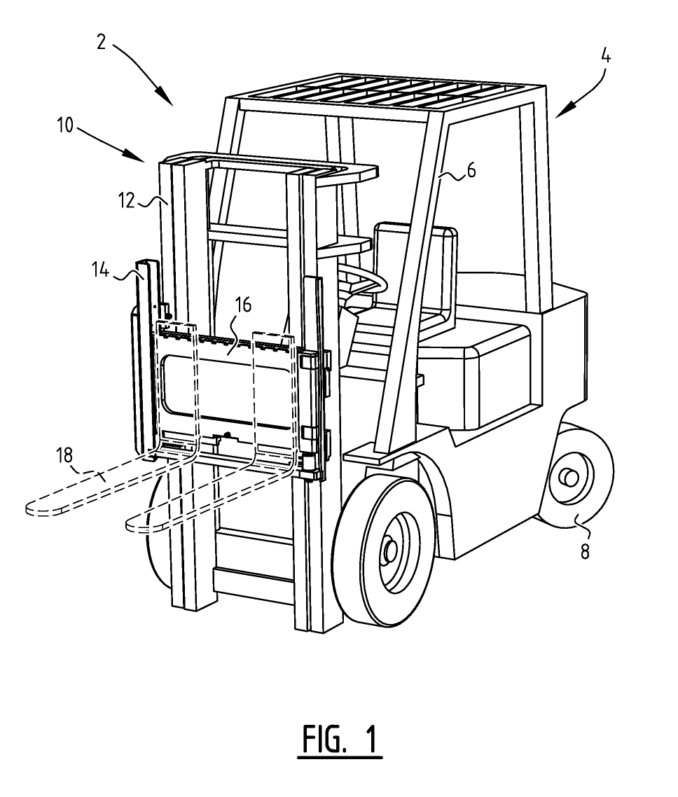

A fork-lift truck 2 (FIG. 1) is provided with a cab 4, chassis 6 and a number of wheels 8. Mast construction 12 is provided on front side 10 of fork-lift truck 2. Construction 12 is provided with two guides 14 in which fork board 16 is arranged for movement. In the shown embodiment two forks 18 (shown in FIG. 1 with broken lines) can be moved in the height using mast construction 12 and/or fork board 16.

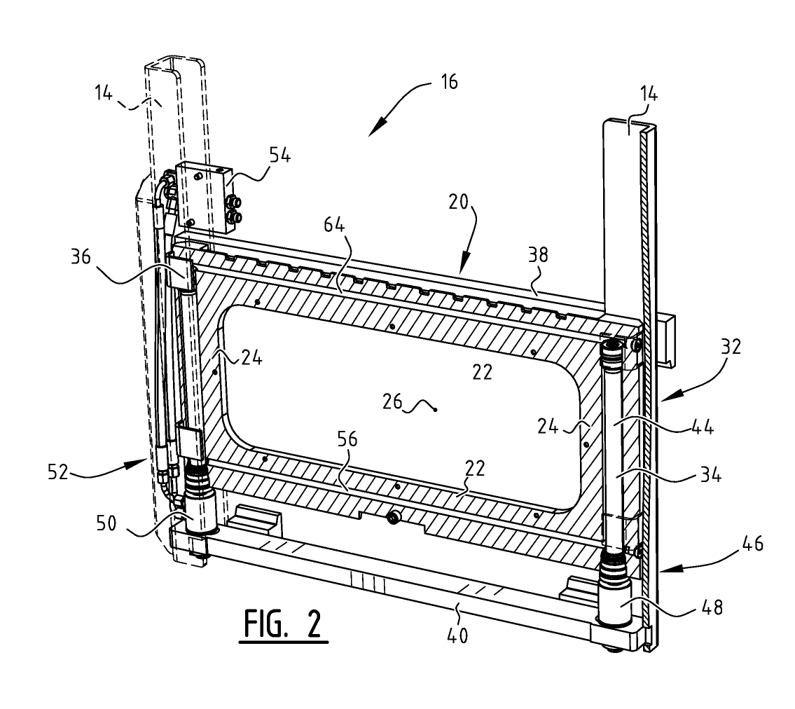

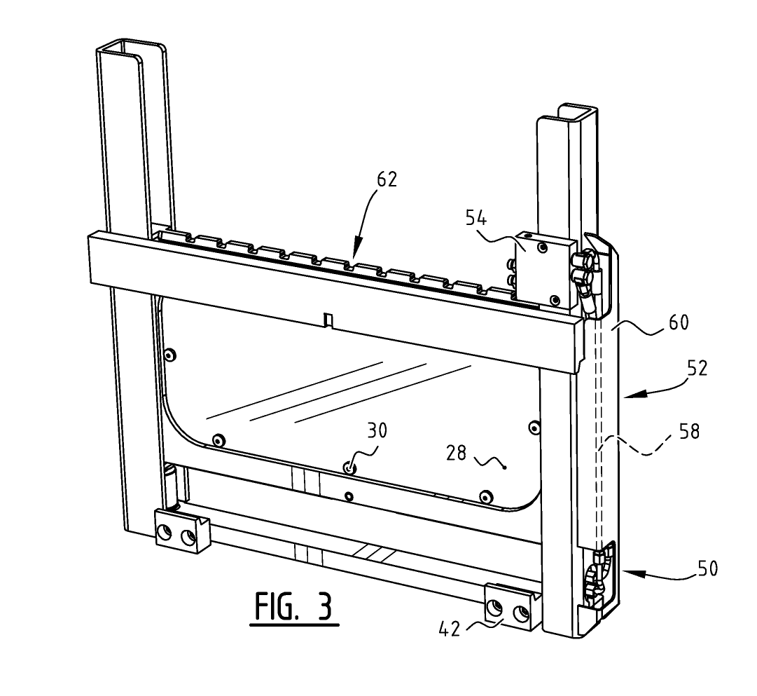

Fork board 16 (FIGS. 2 and 3) is provided with frame 20 with two girders 22 and two uprights 24. Inner area 26 is provided with a plastic plate 28 arranged with couplings 30 to frame 20. Uprights 24 are provided with recess 32 in which cylinder 34 is arranged. Frame 20 moves via wear profile or wear strips 36 in U-shaped guide profiles 14. Guides 14 are mutually connected by girder 38 and connecting beam 40. Beam 40 is connected with coupling parts 42 to the other parts of fork-lift truck 2.

In the shown embodiment cylinders 34 are arranged with cylinder housing 44 in recess 32. Piston rod 46 extends downward from housing 44 to connecting parts 48, 50 arranged on and/or in beam 40. Connecting part 50 is connected in the shown embodiment to oil system 52 provided with valve block 54. Connecting parts 48, 50 are mutually connected via a connecting channel 56 integrally arranged in girder 22. Oil system 52 need hereby be directly connected to only a single connecting part 50, while additional separate cables or conduits are avoided. System 52 is provided with oil lines 58 which connect block 54 to connecting part 50. Lines 58 are covered by cover plate 60.

Girder 22 is provided on the upper side with mounting protrusions 62 for forks 18. Connecting channel 64 is also provided.

Lifting fork board 16 is mounted by means of suspension hooks (not shown) on an existing fork board of a fork-lift truck 2.

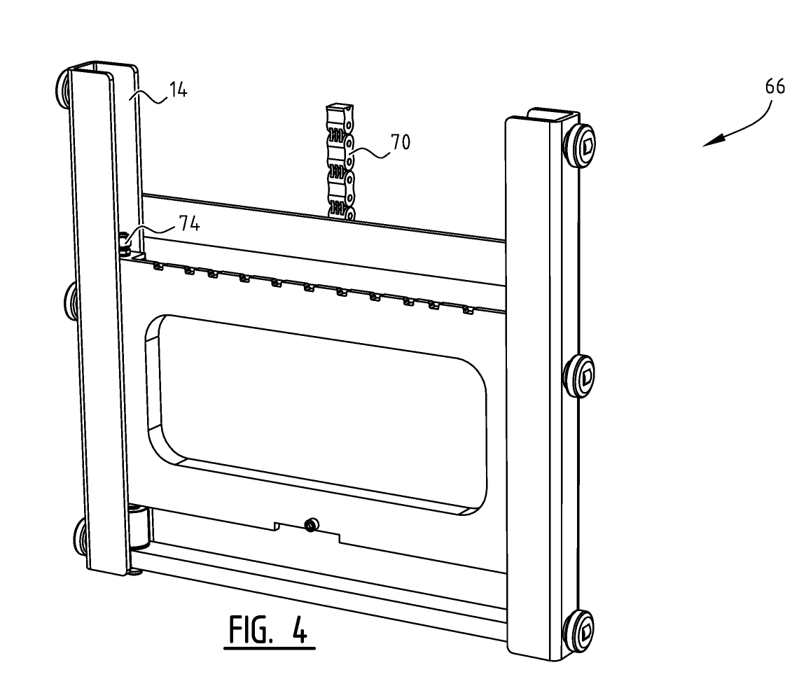

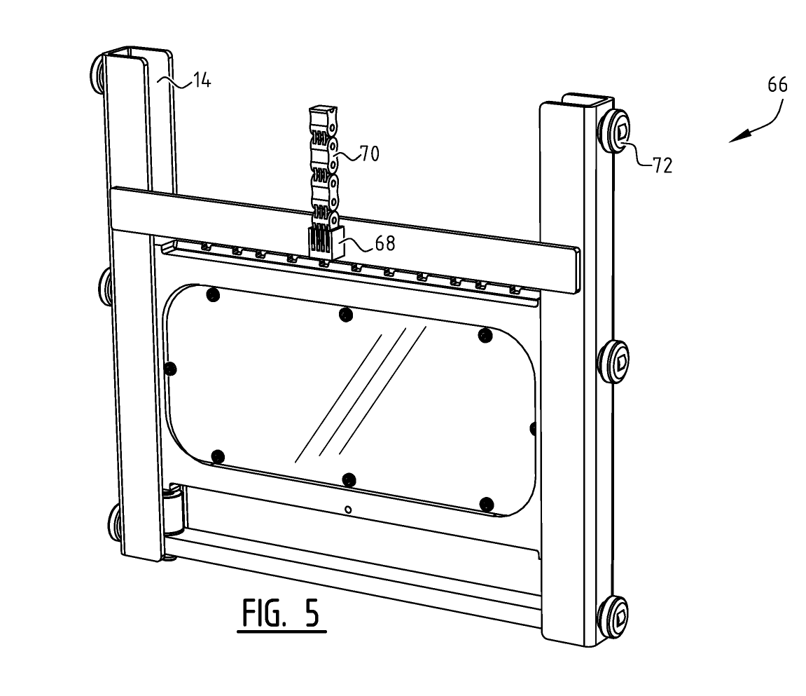

In an alternative embodiment the lifting fork board 66 (FIGS. 4 and 5) is embodied such that fork board 66 including guide 14 can be suspended in a mast of construction 12 of fork-lift truck 2. Chain block 68 provides for the attachment of fork board 66 to mast chain 70. In the shown embodiment guides 14 are provided with guide wheels 72 such that guides 14 can be arranged movably in guides of mast construction 12. Fork board 66 is connected hydraulically via coupling 74 to the oil system of mast construction 12 such that the oil coupling for fork board 66 remains at a fixed position relative to lifting fork board 66. The oil coupling is realized in the shown embodiment by making use of deep drilling techniques. Fork board 66 replaces in the shown embodiment the conventional fork board in the case of an existing fork-lift truck 2.

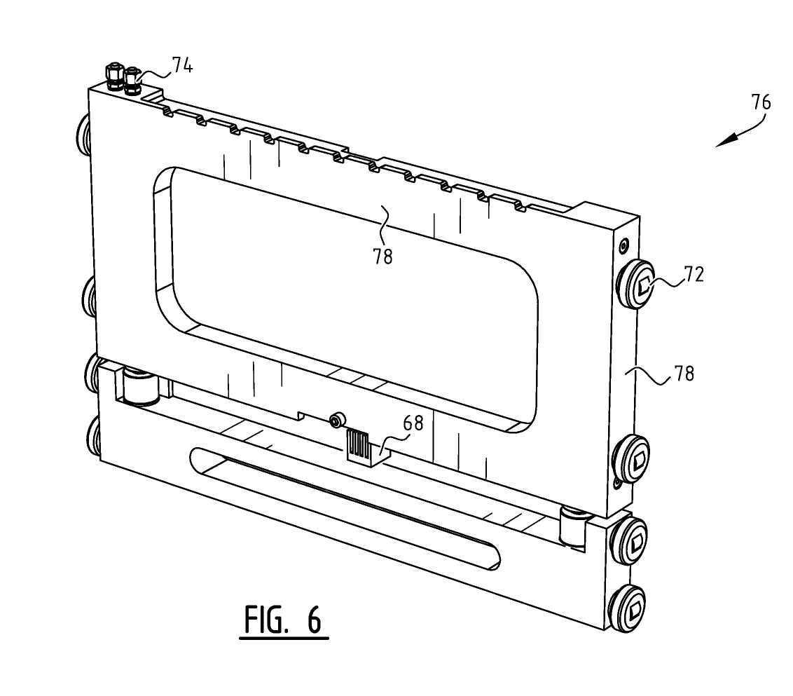

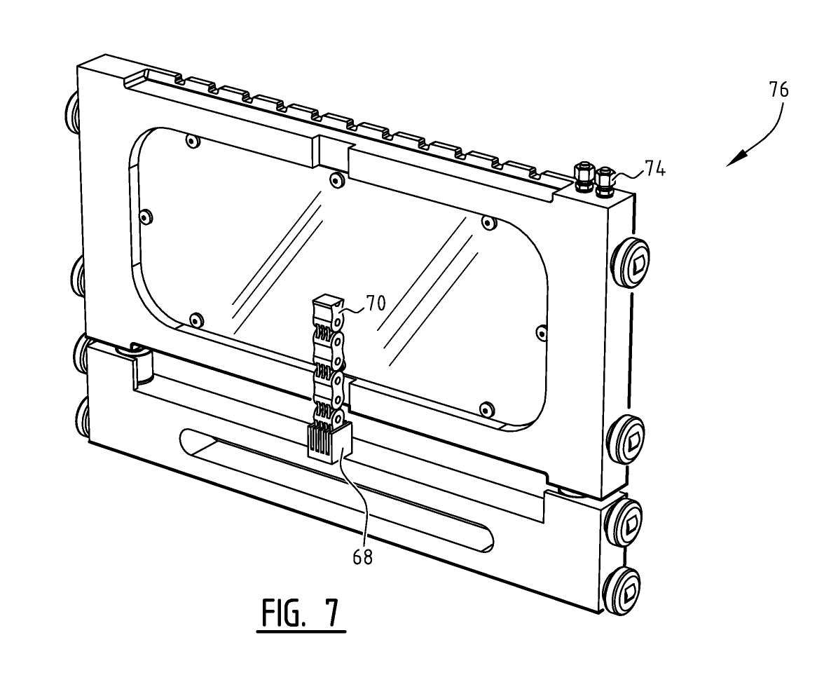

In a further alternative embodiment lifting fork board 76 (FIGS. 6 and 7) is embodied so as to be arranged without integrated guides into mast construction 12 of fork-lift truck 2. Chain block 68 provides for the connection to mast chain 70. In this embodiment of fork board 76 mast profiles in mast construction 12 function as guides for the movement of fork board 76. Guide wheels 72 are arranged for this purpose on side edges 78 of fork board 76. Oil couplings 74 are provided fixedly on frame 78 of fork board 76.

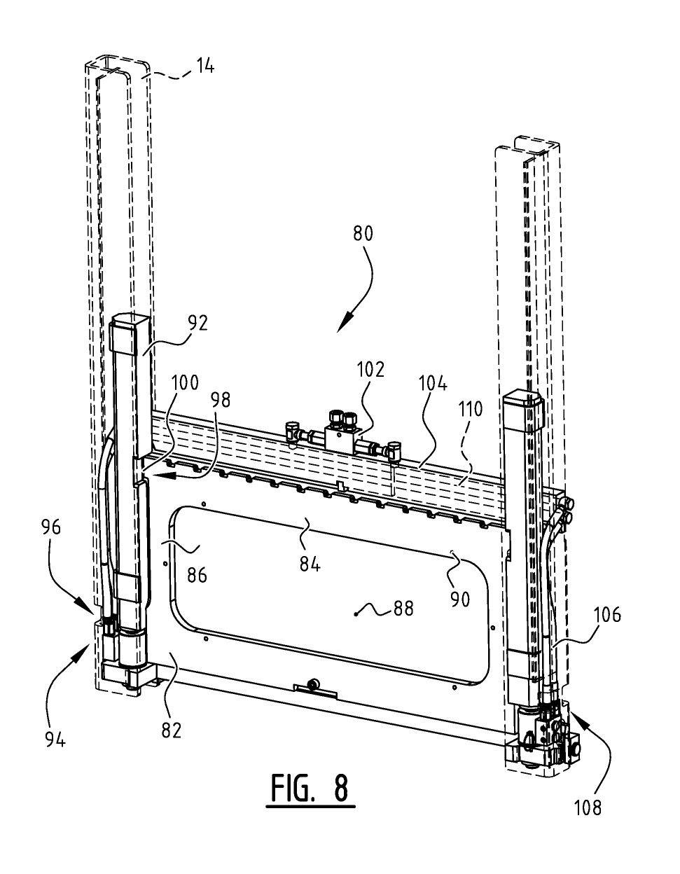

In yet another alternative embodiment lifting fork board 80 (FIG. 8) is provided with frame 82 with two girders 84 and two side edges 86. The inner area is provided with a plastic plate 88 arranged with connections 90 on frame 82. Provided on side edges 86 are uprights 92 in which recess 94 is arranged such that cylinder 96 is arranged therein. Frame 82 is connected to uprights 92 with form closure 98 and/or weld 100. The oil circuit from and to cylinders 96 comprises distributor block 102 mounted on connecting beam 104, a number of oil lines 106 to couplings 108 on or close to cylinders 96. The two cylinders 96 are optionally connected to each other in the oil circuit via internal channels 110. Channels 110 can be provided in beam 104, in girder 84 (not shown), or as conduit on the outer side of beam 104 or girder 84.

In the shown embodiments cylinders 34, 96 are embodied as double-action hydraulic cylinders. It will be apparent that it is also possible to make use of single-action hydraulic cylinders, optionally provided with spring return. The cylinder can optionally also be applied in combination with a sequence valve. Such a sequence valve is applied for instance when the lifting fork board is connected to a cylinder which is used to move the mast parts. In the extreme position of the mast it is possible, by connecting the cylinder of the fork board and the cylinder of the mast in series, to then extend the cylinder of the fork board as extension of the conventional mast. An additional advantage of applying single-action cylinders for the fork board, optionally with sequence valve, is that, in the case single-action cylinders are likewise used for the mast of the fork-lift truck, no additional hydraulic functions are required on the fork-lift for the purpose of operating the fork board. This makes inter alia for simpler application of the lifting fork board on conventional fork-lift trucks.

It will be apparent that different aspects of the separate embodiments of lifting fork board 16, 66, 76, 80 can be applied together and/or interchanged with each other. Running wheels 72 of fork boards 66, 76 could thus also be applied for instance instead of, or conversely in addition to, wear strips 36 of fork board 16. It will also be apparent that so-called horizontal fork adjusters (not shown) can be applied for fork board 16, 66, 76, 80.

When goods are taken up using fork-lift truck 2, forks 18 are placed under the goods which have for instance been set down on a pallet or slip sheet. The forks with goods are then displaced using fork-lift truck 2 to a location where the goods have to be set down. Forks 18 are moved downward here to the desired height, after which the goods are set down, for instance with pallet, at the desired location and at the desired height. For the purpose of moving forks 18 in the height use is made according to the invention of mast construction 12 provided with lifting fork board 16, 66, 76, 80. Lifting fork board 16, 66, 76, 80 can be moved here in a substantially vertical direction relative to mast construction 12 and fork-lift truck 2 without the overall height of fork-lift truck 2 changing.

The present invention is by no means limited to the above described preferred embodiments thereof. The rights sought are defined by the following claims, within the scope of which many modifications can be envisaged. It is also possible to provide a monolithic construction of for instance a single material instead of a frame 78 with two uprights 24 and two girders 22 with internal space 26.

1. A lifting fork board comprising:
a frame provided with coupling means for coupling the fork board to a transport vehicle;
an upright arranged on the frame and provided with a recess; and
a cylinder arranged wholly or partially in the recess of the upright for the purpose of lifting the frame in substantially vertical direction.

2. The lifting fork board as claimed in claim 1, further comprising contact elements for moving the frame in or along a guide which is provided in or on the vehicle.

3. The lifting fork board as claimed in claim 1, wherein a housing of the cylinder is provided in the recess of the upright.

4. The lifting fork board as claimed in claim 3, further comprising at least two uprights provided with a cylinder.

5. The lifting fork board as claimed in claim 4, wherein the cylinders are mutually connected by a hydraulic channel arranged integrally in the frame.

6. The lifting fork board as claimed in claim 5, wherein the hydraulic channel comprises a bore in the frame.

7. The lifting fork board as claimed in claim 1, further comprising a transparent cover plate for safeguarding the frame.

8. The lifting fork board as claimed in claim 1, further comprising a horizontal fork adjuster.

9. A transport vehicle, provided with a lifting fork board as claimed in claim 1.

10. The transport vehicle as claimed in claim 9, wherein two cylinders of the lifting fork board are hydraulically connected by means of a bore in a connecting beam between two sides of the lifting fork board.

11. A method for transporting a cargo, comprising the step of providing a lifting fork board as claimed in claim 1.

12. A method for transporting a cargo, comprising the step of providing a transport vehicle as claimed in claim 9.
